(19) United States
(12) Patent Application Publication
(10) Pub. No.: US 2026/0027757 A1
(43) Pub. Date: Jan. 29, 2026

(54) MOLD WITH MOVABLE CORE, PROCESS FOR FORMING A FOAMED ARTICLE, AND FOAMED ARTICLE

(71) Applicant: Berry Global, Inc., Evansville, IN (US)

(72) Inventors: Roy E. ACKERMAN, Evansville, IN (US); Beau BUENTE, Mount Vernon, IN (US); Braxton John BRAGG, Georgetown, IN (US)

(21) Appl. No.: 19/278,033

(22) Filed: Jul. 23, 2025

Related U.S. Application Data
(60) Provisional application No. 63/674,929, filed on Jul. 24, 2024.

(51) Int. Cl. B29C 44/58; B29C 44/34; B29L 31/00; B65D 1/16

(52) U.S. Cl. CPC B29C 44/583; B29C 44/3415; B29C 44/585; B65D 1/16; B29L 2031/7132

(57) ABSTRACT

A mold is configured to form a polymeric article. The mold includes a first mold portion and a second mold portion. The polymeric article formed by the mold includes regions having varying densities. A method includes forming a cellular polymeric article having regions of varying densities between the first mold portion and the second mold portion.

### PRIORITY CLAIM

This application claims priority under 35 U.S.C. § 119(e) to U.S. Provisional Patent Application No. 63/674,929, filed Jul. 24, 2024, which is expressly incorporated by reference herein in its entirety.

### BACKGROUND

The present disclosure relates generally to a process and apparatus for making an article, and more specifically to a process and apparatus for forming a foamed cup or container.

### SUMMARY

According to the present disclosure, a mold is configured to form a polymeric article. The mold includes a first mold portion and a second mold portion. The first mold portion includes a base surface and a sidewall surface extending in an axial direction away from the base surface. The base surface and the sidewall surface define at least a portion of an interior space. The second mold portion is configured to move relative to the first mold between an opened position and a closed position. In the opened position, the second mold portion is spaced apart from the first mold portion and located outside of the interior space. In the closed position, at least a portion of the second mold portion extends into the interior space of the first mold portion to define a mold cavity between the first mold portion and the second mold portion. The mold cavity is configured to receive a molten polymeric material to form the polymeric article between the first mold portion and the second mold portion.

In illustrative embodiments, the second mold portion includes an interior mold core configured to interface with the base surface of the first mold portion and an exterior mold core configured to interface with the sidewall surface of the first mold portion and formed to include a core interior configured to receive the interior mold core therein. The exterior mold core is configured to move relative to the interior mold core when the second mold portion is in the closed position during a molding operation from a first mold position to a second mold position. In the first mold position, a distal end of the interior mold core is spaced a first distance from a distal end of the exterior mold core. In the second mold position, the distal end of the exterior mold core is spaced a second distance, greater than the first distance, from the distal end of the interior mold core to enlarge the cavity between the first mold portion and the second mold portion and provide the polymeric article with a first projection extending inwardly toward a central axis of the polymeric article.

In illustrative embodiments, the polymeric article is cellular and includes a floor, a brim spaced apart from the floor in a vertical direction, and a sidewall extending between and interconnecting the floor and the brim. The sidewall includes an upper sidewall section, a lower sidewall section, and a medial sidewall section between the upper sidewall section and the lower sidewall section. The upper and lower sidewall sections each have a varying average density in at least a portion thereof. The medial sidewall section has a substantially constant average density throughout an entirety of the medial sidewall section.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a cross section showing a mold for molding a part and includes a first mold portion and a second mold portion and showing the second mold portion in a first molding position within an interior space of the first mold portion to provide a first or initial mold cavity between the first mold portion and the second mold portion;

FIG. 2 is a cross section of the mold of FIG. 1 showing the second mold portion including an interior mold core and an exterior mold core movable relative to the interior mold core and showing the exterior mold core in a second molding position to expand the first or initial mold cavity into a second mold cavity, which may allow the part to expand and/or foam;

FIG. 3 is an enlarged view of a portion of the mold in FIG. 1 showing the exterior mold core in the first molding position;

FIG. 4 is an enlarged view of a portion of the mold in FIG. 2 showing the exterior mold core in the second molding position;

FIG. 5 is an enlarged view of a portion of the mold in FIG. 1 showing the exterior mold core in the first molding position;

FIG. 6 is an enlarged view of a portion of the mold in FIG. 2 showing the exterior mold core in the second molding position;

FIG. 7 is an enlarged view of a medial region of the formed part within the mold cavity showing the formed part including an inner layer having a first density, an outer layer having a second density, and a core layer having a third density less than the first and second densities;

FIG. 8 is an enlarged view of a lower region of the formed part within the mold cavity showing the formed part including the inner layer having a first density, an outer layer having a second density, and a core layer having a third density less than the first and second densities;

FIG. 9 is an enlarged view of an upper region of the formed part within the mold cavity showing the formed part including the inner layer having a first density, an outer layer having a second density, and a core layer having a third density less than the first and second densities;

FIG. 10 is a cross section of a second embodiment of a mold including a first mold portion and a second mold portion, the second mold portion including an interior mold core and a movable exterior mold core in a first molding position;

FIG. 11 is a cross section of the mold of FIG. 11 showing the exterior mold core in a second molding position;

FIG. 12 is a cross section of a third embodiment of a mold including a first mold portion and a second mold portion, the second mold portion including an interior mold core, a first movable exterior mold core, and a second movable exterior core, the first and second movable exterior cores in a first molding position;

FIG. 13 is a cross section of the mold of FIG. 12 showing the first and second movable exterior cores in a second molding position;

FIG. 14 is a cross section of the mold of FIG. 12 showing the first and second movable exterior cores in a third molding position.

### DETAILED DESCRIPTION

A mold 10 is configured to form a polymeric article 12. The mold 10 is configured to establish a mold cavity 14. Polymeric material is provided in the mold cavity 14, for example by being injected into the mold cavity 14 in a molten state, and forms the polymeric article 12 after cooling and solidifying. The polymeric article 12 is illustratively embodied as a drink cup, but can take other forms such as a lid, tray, bowl, plate, bucket, container or any other suitable article.

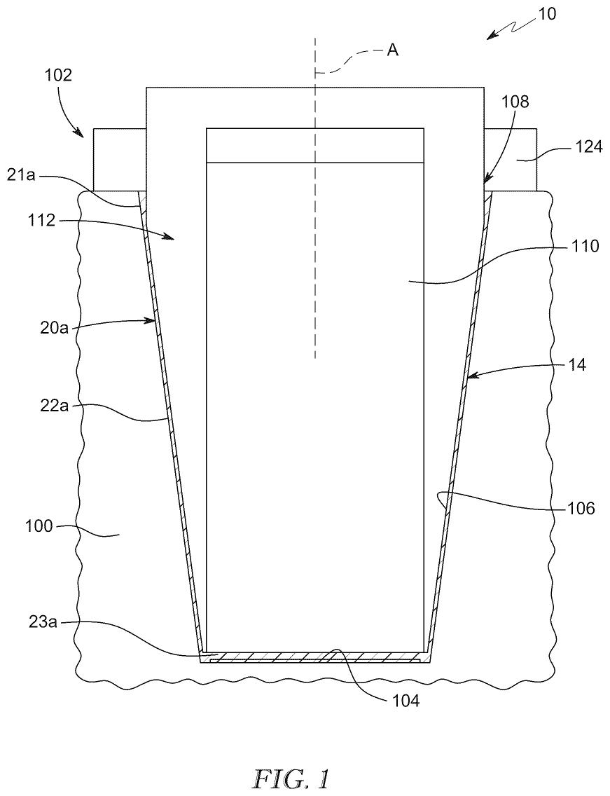

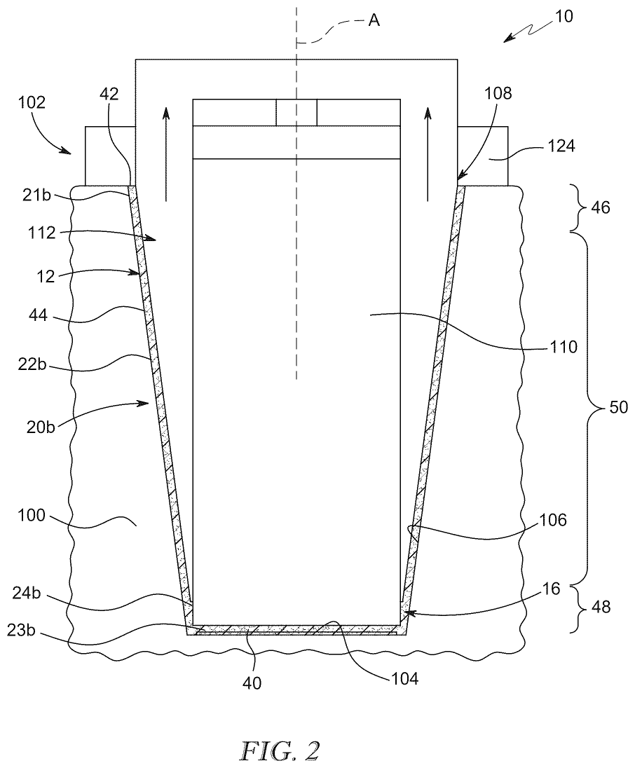

In illustrative embodiments, the mold 10 includes a first mold portion 100 and a second mold portion 102 as shown in FIGS. 1 and 2. The first mold portion 100 (also called a female or stationary mold) includes a base surface 104 and a sidewall surface 106 extending in an axial direction away from the base surface 104. The base surface 104 and the sidewall surface 106 define at least a portion of an interior space 108. The second mold portion 102 (also called a male or a movable mold) is configured to extend into the interior space 108 and interfaces with the base surface 104 and the sidewall surface 106 to provide the mold cavity 14 therebetween.

The second mold portion 102 is configured to move relative to the first mold portion 100 between an opened position and a closed position. In the opened position, the second mold portion 102 is removed from the interior space 108 so that the polymeric article 12 can be ejected from the interior space, for example. In the closed position, at least a portion of the second mold portion 102 extends into the interior space 108 of the first mold portion 100, as shown in FIGS. 1 and 2, to define the mold cavity 14 between the first mold portion 100 and the second mold portion 102.

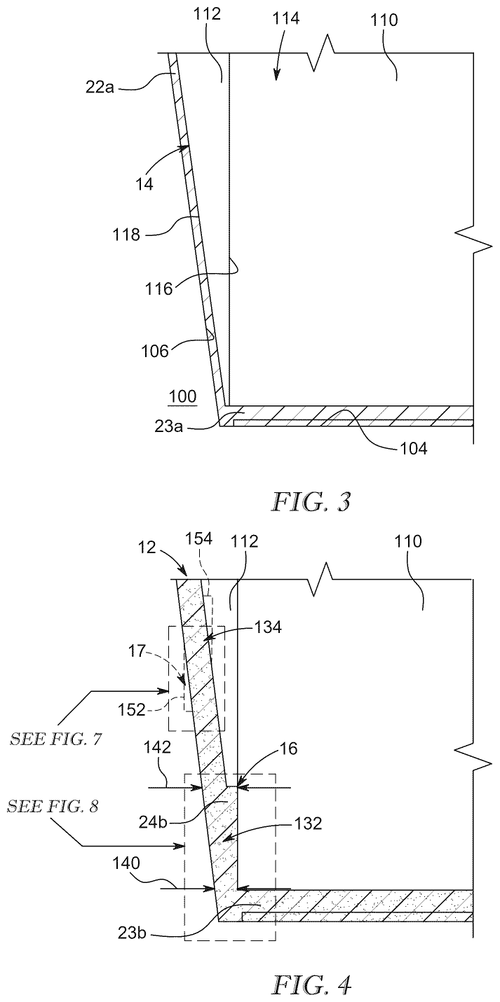

The second mold portion 102 includes an interior mold core 110 configured to interface with the base surface 104 of the first mold portion 100 and an exterior mold core 112 configured to interface with the sidewall surface 106 of the first mold portion 100. The exterior mold core 112 is formed to include a core interior 114 configured to receive the interior mold core 110 therein, as shown for example in FIG. 3.

The exterior mold core 112 is configured to move relative to the interior mold core 110 when the second mold portion 102 is in the closed position during a molding operation from a first mold position, as shown in FIG. 1, to a second mold position as show in FIG. 2. In the first mold position, a distal end of the interior mold core 110 is spaced a first distance from a distal end of the exterior mold core 112 and the exterior mold core 112 extends deeper into the interior space 108. In the second mold position, the distal end of the exterior mold core 112 is spaced a second distance, greater than the first distance, from the distal end of the interior mold core 110 and is withdrawn a greater extent from the interior space 108 to enlarge the mold cavity 14 between the first mold portion 100 and the second mold portion 102. Enlarging the mold cavity 14 allows the molten polymeric material to expand and provides the polymeric article 12 with a first projection 16 extending inwardly toward a central axis A of the polymeric article 12. In some embodiments, the projection 16 is a stacking shoulder or a rigidifying feature for the polymeric article. The projection 16 may extend entirely around the central axis A or only partway around the central axis A.

The interior mold core 110 remains stationary throughout the molding operation until the molten polymeric material is cooled and solidified a sufficient amount to be ejected. Once the polymeric article 12 is formed, the interior and exterior mold cores 110, 112 move in unison to the opened position so that the polymeric article can be ejected from the interior space 108.

The exterior mold core 112 includes an inner surface 116 defining the core interior 114 and an outer surface 118 having a tapered surface 120 and a planar surface 122. The tapered surface 120 is arranged at an angle to the axial direction of the exterior mold core 112 and central axis A. The planar surface 122 is parallel to the axial direction of the exterior mold core 112 and the central axis A. The planar surface 122 is located at least partially in the interior space 108 in the first mold position and is located outside of the interior space 108 in the second mold position.

The second mold portion 102 further includes a seal ring 124 as shown in FIGS. 1 and 2. The seal ring 124 is configured to engage with the planar surface 122 to provide a sealing interface therebetween when the exterior mold core 112 is in the first mold position and the second mold position. The seal ring 124 may also engage with a top end of the first mold portion 100 at an outer edge of an inlet into the interior space 108 to provide a seal between the first mold portion 100 and the second mold portion 102.

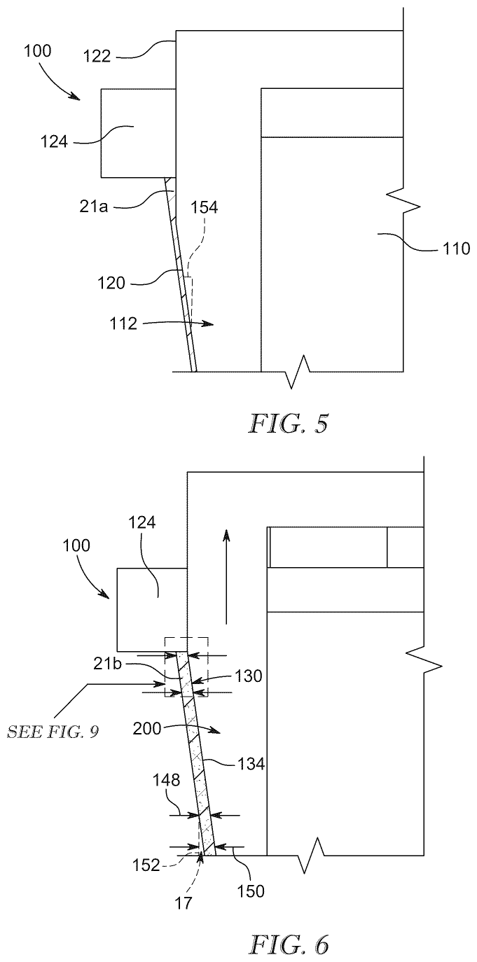

The mold cavity 14 changes in various dimensions as the exterior mold core 112 of the second mold portion 102 moves relative to the first mold portion 100 as shown in FIGS. 1-6. The cavity 14 increases in width along an entirety of a height of the sidewall surface 106 of the first mold portion 100 as the exterior mold core 112 moves from the first mold position to the second mold position. However, the increase in width is different in upper, lower, and medial cavity regions 130, 132, 134.

The lower region 132 may have the greatest increase in width due to the exterior mold core 112 moving upwardly and being offset completely from a lower extent of the sidewall surface 106 in a radial direction perpendicular to the axial direction. A lower extent of the lower region 132 has a smaller increase in width in comparison to an upper extent of the lower region 132 as shown in FIG. 4. This provides the lower region 132 with a first width 140 at a lower end of the lower region 132 and a second width 142, greater than the first width 140 at an upper end of the lower region 132. The lower region 132 increases in width linearly from the lower end thereof to the upper end thereof. The upper end of the lower region 132 provides the projection 16. The projection 16 may provide a stacking lug 24b used to maintain spacing between two articles 12 stacked with one another.

The upper region 130 may have a smaller increase in width in comparison to the lower region 132. A lower extent of the upper region 130 has a greater increase in width in comparison to an upper extent of the upper region 130 as shown in FIG. 6. This provides the upper region 130 with a first width 144 at a lower end of the upper region 130 and a second width 146, greater than or equal to the first width 144 at an upper end of the lower region 132. The first and second widths 144, 146 of the upper region 130 are less than the second width 142 of the lower region 132. Depending on a location of a transition point between the tapered surface 120 and the planar surface 122, the upper region 130 may have a third width at the transition point less than the first and second widths 144, 146 and located between the first and second widths 144, 146. If the transition point is aligned with the upper end of the upper region 130 in the second mold position, then the width of the upper region 130 is substantially constant along an entirety thereof. This could help with mold release and/or more control of the brim geometry after foaming/expanding.

The medial region 134 extends between and interconnects the upper and lower regions 130, 132 as shown in FIGS. 4 and 6. The medial region 134 has a constant increase in width as the exterior mold core 112 moves from the first mold position to the second mold position. In other words, the medial region 134 has a substantially constant width 148 along an entirety thereof in the illustrative embodiment. In some embodiments, the sidewall surface 106 may be formed to include one or more notches 152 providing the sidewall surface 106 with a non-constant increase in diameter from the base surface 104 along a height thereof. The notches 152, if included, provide a greater width 150 in the medial region 134 and result in an additional projection(s) 17 being formed in the polymeric article 12 as a stacking shoulder or a stiffening region. The additional projection(s) 17 may extend entirely around the central axis A or only partway around the central axis A. In some embodiments, the exterior mold core 112 may be formed to include one or more notches 154 in addition to notches 152 or in place of notches 152. Each of the notches 152, 154 preferably does not include any surface angled toward the central axis A in the part removal direction to facilitate part removal from the interior space 108.

The polymeric material(s) or formulation used to form the polymeric article 12 may include a blowing agent (i.e. a chemical blowing agent and/or a physical blowing agent) that causes the polymeric material to foam within the cavity 14 as the exterior mold core 112 moves from the first mold position to the second mold position. In this way, the polymeric article 12 may be cellular in at least a portion thereof and can have one or more regions of varying density.

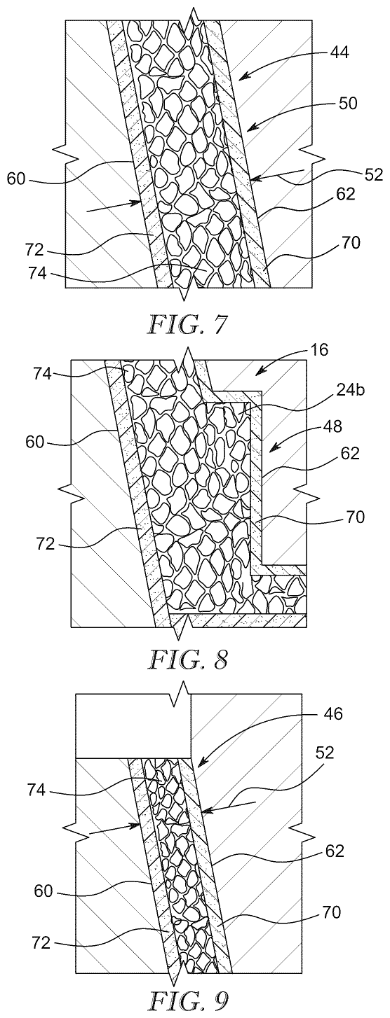

The polymeric article 12 includes a floor 40, a brim 42 spaced apart from the floor in a vertical direction, and a sidewall 44 extending between and interconnecting the floor 40 and the brim 42 as shown in FIGS. 7-9, 13, and 14. The floor 40 is formed between the base surface 104 and the interior mold core 110 in the mold 10. The sidewall 44 is formed between the sidewall surface 106 and both the exterior mold core 112 and the interior mold core 110 of the mold 10 when the exterior mold core 112 is in the second mold position. The brim 42 defines an open mouth into the article 12 and may be formed between the first mold portion 100 and the second mold portion at an upper end of the first mold portion 100. Any or all of the floor 40, brim 42, and sidewall 44 may be include foaming, as well as any other component or feature of article 12.

The sidewall 44 includes an upper sidewall section 46, a lower sidewall section 48, and a medial sidewall section 50 between the upper sidewall section 46 and the lower sidewall section 48. The upper and lower sidewall sections 46, 48 each have a varying average density in at least a portion thereof. The medial sidewall section 50 may have a substantially constant average density, and/or one or more densities that are less than the density at an outer surface 60 and an inner surface 62, throughout an entirety of the medial sidewall section 50.

The varying densities of the upper and lower wall sections 46, 48 form as a result of the change in width of the cavity 14 in each section as the exterior mold core 112 moves to the second mold position. The change in width of the cavity 14 results in varying thicknesses in each section 46, 48, 48 of the sidewall. In some embodiments, the upper sidewall section and the medial sidewall section 46, 50 have a first thickness 52 and the lower sidewall section 48 has a second thickness 54 greater than the first thickness 52.

In the illustrative embodiment, the medial sidewall section 50 has a thickness of no more than 0.11 inches. In some embodiments, the thickness of the medial sidewall section 50 is within a range of 0.06 inches to 0.11 inches. In some embodiments, the thickness of the medial sidewall section 50 is within a range of 0.07 inches to 0.11 inches. In some embodiments, the thickness of the medial sidewall section 50 is within a range of 0.08 inches to 0.11 inches. In some embodiments, the thickness of the medial sidewall section 50 is within a range of 0.09 inches to 0.11 inches. In some embodiments, the thickness of the medial sidewall section 50 is within a range of 0.1 inches to 0.11 inches. It should be noted that the medial cavity region 134 also has a thickness that is substantially the same but slightly larger than the thickness of the medial sidewall section 50 by way of being the part that forms the medial sidewall section 50 and establishes its thickness.

The polymeric material is initially injected into the mold cavity 14 while the mold cavity 14 is in the first molding position and has a thickness along the medial cavity region 134 less than the thickness of the medial sidewall section 50 of the polymeric article 12. Moving the second mold portion 102 to the second molding position widens the mold cavity and allows the polymeric material to foam and fill the now wider mold cavity 14. In some embodiments, the mold cavity 14 thickness along the medial cavity region 134 is within a range of 0.02 inches to 0.06 inches. In some embodiments, the mold cavity 14 thickness along the medial cavity region 134 is within a range of 0.03 inches to 0.05 inches. In some embodiments, the mold cavity 14 thickness along the medial cavity region 134 is about 0.04 inches.

The sidewall 44 has an outer surface 60 extending along the upper sidewall section 46, the lower sidewall section 48, and the medial sidewall section 50 and an inner surface 62 extending along the upper sidewall section 46, the lower sidewall section 48, and the medial sidewall section 50. The outer surface 60 may have a constant increase in diameter along a height of the sidewall 44 from the floor 40 to the brim 42. The inner surface 62 may have a variable change in diameter along the height of the sidewall 44 from the floor 40 to the brim 42. In some embodiments, the outer surface 60 may change in diameter more gradually (i.e. along a curve) to achieve a step feature. In some embodiments, the inner surface 62 has a substantially constant diameter along a height of the lower sidewall section 48 and a constant increase in diameter along a height of the medial sidewall section 50 and/or the upper sidewall section 46. In some embodiments, the inner surface 62 does not decrease in diameter from the floor to the brim. If the mold 10 includes notches 152, the inner surface 62 has a substantially constant diameter along a height of the lower sidewall section 46, a constant increase in diameter along a first portion of the medial sidewall section 50, and a second substantially constant diameter along a second portion of the medial sidewall section 50 spaced apart from the substantially constant diameter along the height of the lower sidewall section 48. The second substantially constant diameter occurs where the notches 152 are formed in the first mold portion 100.

In illustrative embodiments, the sidewall 44 includes an inner layer 70 having a first density, an outer layer 72 having a second density, and a core layer 74 between the inner layer 70 and the outer layer 72 having a third density less than the first and second densities as shown in FIGS. 7-9. The first and second densities may be the same or different. The third density is less than the first and second densities do to expansion of the core layer 74 within the mold cavity 14.

The inner and outer layers 70, 72 may form as a result of pressure being exerted on the first and second mold portions 100, 102 as the polymeric material expands in the cavity 14 and/or as a result of cooling due to contact with the mold or cavity surface(s) that may, for example, result in freezing/solidifying of the outer layers 70, 72. To aid in cooling, the mold or cavity surface(s) may be cooled, for example, by running cooling fluid to or near some or all of those surfaces.

While the inner and outer layers are shown in FIGS. 7-9 are being solid, it should be understood that the inner and outer layers may include some smaller cells in comparison to the core layer 74. Further, the sidewall 44 may transition from a relatively high density in the inner and outer layers 70, 72 to a lower density in the core layer 74 such that the density of the sidewall is highest at the inner and outer surfaces 60, 62 and gradually decreases toward the core layer 74. The transition from higher to lower density may be abrupt (i.e. within a distance less than 10% of the thickness of the sidewall 44) or more drawn out (i.e. within a distance greater than 20% of the thickness of the sidewall 44).

The first and second layers 70, 72 form the outer and inner surfaces 60, 62 of the sidewall 44. The outer surface of the sidewall 44 may have a surface roughness substantially the same as a comparative unfoamed (non-cellular), injection-molded article. However, the polymeric article 12 in the illustrative embodiment includes a foamed, cellular core 74 to increase insulative properties of the polymeric article 12. The more dense inner and outer layers 70, 72 rigidify the polymeric article 12 for greater top load strength and reduced deformation while being gripped by a user, for example. Some comparative foamed articles do not include a more dense inner and/or outer layer 70, 72 because at least one of the molds is completely separated from the polymeric material as the polymeric material foams. Thus, in such comparative articles, the cellular structure of the foamed material causes a bumpy, more rough inner and/or outer surface.

In some embodiments, the polymeric article 12 may be formed by a processes including in-mold labeling. In this case, the polymeric article 12 may further include a film laminated on the outer surface 60 and/or the inner surface 62. The film may include a barrier layer, such as EVOH. The film may include ink printed thereon.

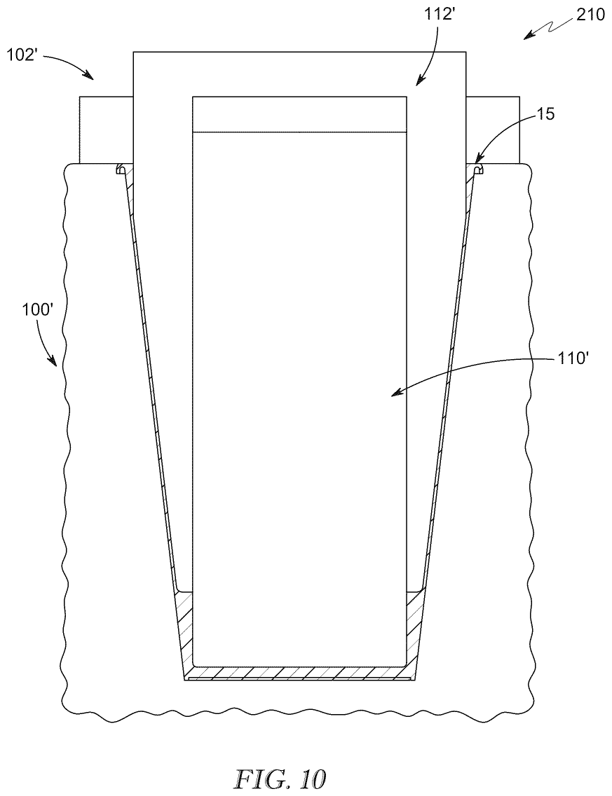

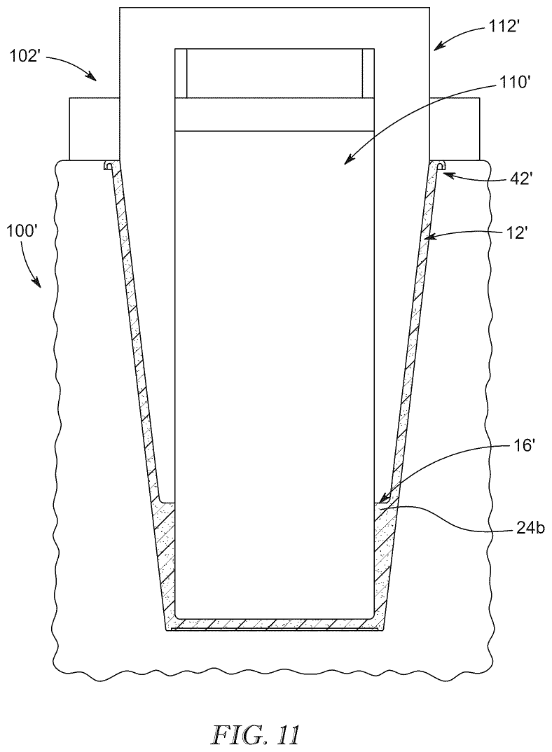

Another embodiment of a mold 210 configured to form a polymeric article 12′ is shown in FIGS. 10 and 11. The mold 210 is substantially similar to mold 10 and includes a first mold portion 100′ and a second mold portion 102′. The first and second mold portions 100′, 102′ are identical to mold portions 100, 102 except for the differences described below.

The second mold portion 102′ includes an interior mold core 110′ and an exterior mold core 112′. A distal end 113′ of the exterior mold core 112′ is spaced a first, non-zero distance 116′ from a distal end 111′ of the interior mold core 110′ in a first mold position as shown in FIG. 10. The distal end 113′ of the exterior mold core 112′ is spaced a second distance 118′ from the distal end 111′ of the interior mold core 110′ in a second mold position as shown in FIG. 11. This allows a projection 16′ to be formed in the polymeric article 12′ at a higher elevation in comparison to projection 16 of polymeric article 12 while still maintaining a similar sidewall thickness 150′.

The first mold portion 100′ is formed to include an additional cavity space 15 to form a brim 42′ of the polymeric article 12′. The brim 42′ has a curved upper surface and a distal end providing an outermost diameter of the polymeric article 12′.

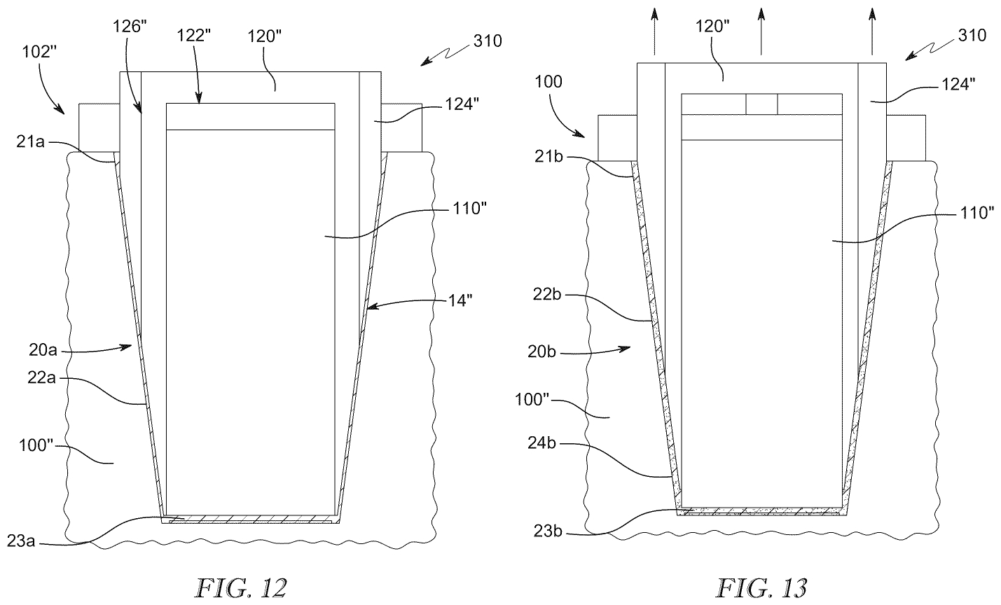

Another embodiment of a mold 310 is shown in FIGS. 12-14. The mold 310 is substantially similar to mold 10 and includes a first mold portion 100″ and a second mold portion 102″. The first and second mold portions 100″, 102″ are identical to mold portions 100, 102 except for the differences described below.

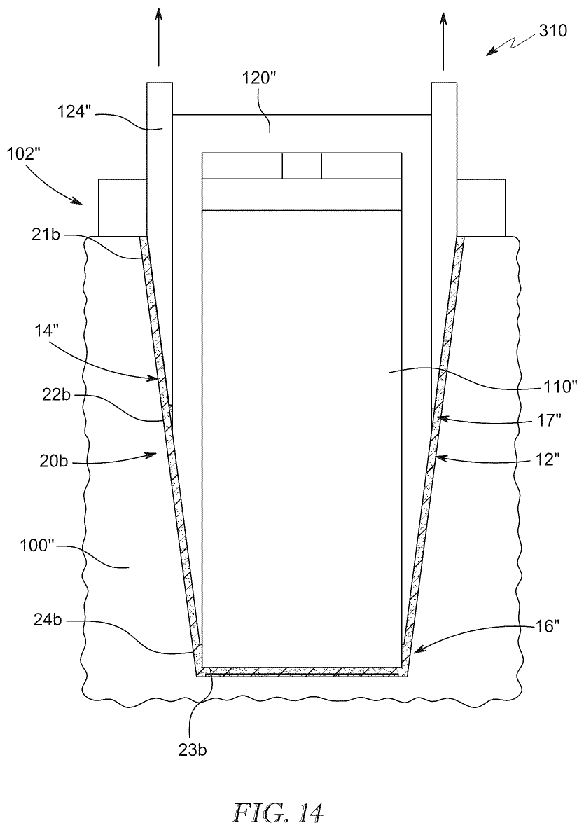

The second mold portion 102″ includes an interior mold core 110″ and an exterior mold core 112″. The exterior mold core 112″ includes a first movable core 120″ defining a core interior 122″ and a second movable core 124″ defining a second core interior 126″ configured to receive the first movable core 120″. The first and second movable cores 120″, 124″ are configured to move or translate relative to the interior mold core 110″ and the first mold portion 100″ in unison with one another from a first mold position, as shown in FIG. 12, to a second mold position, as shown in FIG. 13 to enlarge a portion of the cavity 14″ and provide a first projection 16″ in the polymeric article 12″. The second movable core 124″ is configured to move or translate relative to the first movable core 120″, the interior mold core 110″, and the first mold portion 100″ from the second mold position to a third mold position as shown in FIG. 14. The third mold position enlarges a second portion of the cavity 14″ and provides a second projection 17″ in the polymeric article 12″ spaced apart from the first projection 16″ in the axial direction. In some embodiments, the second mold portion 102″ can include more than two movable cores (i.e. three, four, five, etc.) to provide a corresponding number of projections on the polymeric article 12″. The various movable cores can be moved relative to the interior core 110″ by dual action on one side of the mold 310 or with a mechanical stop that moves one set and then the other set/core at the same time or in a sequence.

A method of forming a polymeric article 12 includes establishing a mold cavity 14 between a first mold portion 100 and a second mold portion 102. The method further includes injecting molten polymeric material into the mold cavity 14 between the first mold portion 100 and the second mold portion 102. The method further includes foaming the polymeric material within the mold cavity 14.

The method further includes moving a portion 112 of the second mold portion 102 relative to the first mold portion 102 to enlarge the mold cavity in at least one selected region. This causes the polymeric article 12 to have a first density in the at least one selected region and a second density, greater than the first density, in a second region offset axially from the at least one selected region relative to a central axis A of the polymeric article 12. In some embodiments, the cavity 14 is sealed off and widening the cavity 14 decreases pressure in the cavity 14 to allow the polymeric material to foam or expand.

During the step of foaming, the portion 112 of the second mold portion 102 translates relative to the first mold portion 100 from a first mold position extending a first distance into the mold cavity 14 to a second mold position extending a second distance less than the first distance into the mold cavity 14. The first mold portion 100 and the second mold portion 102 remain in contact with the polymeric material until the polymeric material is at least partially solidified. In this way, the first mold portion 100 forms a first high-density layer 70 in the polymeric article 12, the second mold portion 102 forms a second high-density layer 72 in the polymeric article 12, and a low-density medial layer 74 is formed between the first high-density layer 70 and the second high-density layer 72 as the polymeric material foams.

In some embodiments, the method includes a step of inserting a label into the mold cavity prior to the polymeric material being injected into the mold cavity. In some embodiments, the method includes a step of cooling the polymeric material in the mold cavity by circulating a cooling fluid in one or both of the first mold portion 100 and the second mold portion 102.

Some embodiments of a mold and process for providing a foamed cup include a mold 10, as shown for example in FIG. 1. Mold 10 may be an injection molding type mold. Mold 10 may include an upper portion 110, a movable core 112, and/or a lower portion 100. Movable core 112 may be in a first closed position relative to upper portion 110 and/or lower portion 100, as shown in FIG. 1 for example. Upper portion 110, movable core 112, and/or lower portion 100 may cooperate to form a first or initial cavity for a first or initial part 20a. As shown in FIG. 1, initial part 20a may take the form of a cup having an initial brim 21a, an initial sidewall 22a, and an initial floor 23a.

As shown in FIG. 2, movable core 112 may be moved relative to upper portion 110 and/or lower portion 100 from the first closed position into a second closed position as indicated by the pair of vertical arrows. Such motion of movable core 112 may enlarge or expand the cavity for the part into a second or final cavity for a second or final part 20b. Final part 20b may be thicker than initial part 20a and/or the cavity in the second closed position may be larger than the cavity in the first closed position. The larger cavity in the second position may allow the material of initial part 20a to expand and/or foam into a thicker final part 20b without substantially increasing the weight of final part 20b relative to initial part 20a. Final part 20b may have improved insulation, for example thermal insulation, relative to initial part 20a due to an increased thickness, presence of foaming and/or cellular material in final part 20b, or for any other reason.

A central area 110 of mold upper portion 110 may extend axially or vertically toward or to initial floor 23a and/or a final floor 23b of final part 20b, as shown for example in FIG. 2. Movable core 112 may have a substantially conical shape as shown for example with a cylindrically hollowed out central region to accommodate a substantially cylindrical central area 110 of mold upper portion 110. Movable core 112 may move and/or slide vertically or axially relative to central area 110. In doing so, a stacking feature 24b may be allowed to form by foaming or otherwise, which may be provided to facilitate stacking of multiple final parts 20b together while also facilitating easy removal of one stacked final part 20b from another.

Stacking feature 24b may be substantially circumferentially continuous or may be intermittent forming one or more rib like structures. A close up view showing stacking feature 24b in more detail is provided in FIG. 4. Movable core 112 may have a substantially planar surface above a substantially tapered or angled surface as shown in FIG. 2, for example, to facilitate providing a final brim 21b that expands less and/or foams less than an adjacent area of final sidewall 22b. This configuration may, for example, provide final brim 21b that is more rigid and/or has more tightly controlled dimensions than final sidewall 22b.

FIGS. 10 and 11 illustrate a second embodiment of a mold that may be used to form a part similar in function and process as mold 10. One difference of the second mold embodiment shown in FIGS. 10 and 11 is that the lower end of the movable core does not extend as far down as it does in mold 10. This relatively shorter movable core may provide and/or facilitate the presence of a stacking feature in the initial part prior to expansion and/or foaming of the part. Such a configuration may allow for providing a larger stacking feature, tighter control in the performance of the stacking feature, and/or additional dimensional control over the stacking feature, for example. As shown in FIG. 2 in close up, the moving or movable core may form a straight section at the top of the part at or near the brim. This may allow the moving core to retract and still seal the cavity, for example, or may be provided for any of a variety of reasons or combination thereof.

The vertical or axial motion of movable core 112 relative to upper portion 110 and/or lower portion 100 may be relatively slow compared to the rate of expansion and/or foaming of the material in initial part 20a and/or final part 20b. All foaming may occur while the material in initial part 20a remains in contact with at least one of movable core 112, upper portion 110, and/or lower portion 100 until movement is finished and final part 20b is formed. In illustrative embodiments, no foaming occurs once the mold 10 is opened for part release/ejection. Controlling the velocity and/or movement of movable core 112 to keep part 20a, 20b in contact with a mold surface at all times may allow for formation of relatively smooth skin layers while expansion or foaming occurs between the skin layers. In other words, the inner and outer skin layers have a different (i.e. higher) density than the core layer but all of the layers have the same composition of materials.

Chemical blowing agents (CBA) and/or physical blowing agents (PBA) may be used in the material used to form part 20a, 20b. The pressure drop in the material due to movement of movable core 112 enlarging the part cavity may cause relatively fast or instantaneous part expansion. In one example, the expansion time needed for the material to fill the final cavity for final part 20b is about 0.03 seconds. In this example, the movable core 112 takes about 0.05 seconds to move from the first closed position to the second closed position. Thus, the expansion of the cavity limits the rate at which the material can expand and the material stays in contact with the mold surfaces throughout the movement from the first closed position to the second closed position and/or throughout the process of forming a foamed final part 20b.

It is understood that part 20a, 20b, and/or any component thereof, may be made of any of a variety of materials, including, but not limited to, any of a variety of suitable plastics material, any other material, or any combination thereof. Suitable plastics material may include, but is not limited to, polypropylene (PP), polyethylene (PE), polyethylene terephthalate (PET), polystyrene (PS), high-density polyethylene (HDPE), low-density polyethylene (LDPE), linear low-density polyethylene (LLDPE), crystallized polyethylene terephthalate (CPET), mixtures and combinations thereof, or any other plastics material or any mixtures and combinations thereof. It is understood that multiple layers of material may be used for any of a variety of reasons, including to improve barrier properties, or to provide known functions related to multiple layer structures. The multiple layers, if included, may be of various materials, including but not limited to those recited herein.

It is further understood that part 20a, 20b, and/or any component thereof, may be substantially rigid, substantially flexible, a hybrid of rigid and flexible, or any combination of rigid, flexible, and/or hybrid, such as having some areas be flexible and some rigid. It is understood that these examples are merely illustrative, are not limiting, and are provided to illustrate the versatility of options available in various embodiments of part 20a, 20b, and/or any component thereof.

It is further understood that any of a variety of processes or combination thereof may be used to form part 20a, 20b, and/or any component thereof, or any layer or substrate used therein. For example, any component, layer, or substrate, or combination thereof, may be compression molded, thermoformed, injection molded, injection stretch blow molded, blow molded, extrusion blow molded, coextruded, subjected to any other suitable process, or subjected to any combination thereof. In some embodiments, part 20a, 20b, and/or any component thereof may be formed substantially of injection molded and/or thermoformed suitable plastics material, although other materials and forming processes may be used instead of or in addition to injection molding and thermoforming, respectively. Various materials and/or processes may be used to form part 20a, 20b, and/or any component thereof, as will be understood by one of ordinary skill in the art. In some embodiments, part 20a, 20b, and/or any component thereof, may be substantially a one-piece design and/or substantially formed as an integral or unitary structure.

It is understood that, while some directional terms are used herein, such as top, bottom, upper, lower, inward, outward, upward, downward, etc., these terms are not intended to be limiting but rather to relate to one or more exemplary orientations, positions, and/or configurations of part 20a, 20b, and/or any component thereof. It is understood part 20a, 20b, and/or any component or portion thereof may be inverted or re-oriented to face or point a different direction without departing from the nature of part 20a, 20b disclosed herein.

Embodiments described herein with reference to the accompanying drawings, include some, but not all embodiments contemplated. Indeed, embodiments may take many different forms and the present disclosure should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The terms “substantial” or “substantially” may encompass the whole as specified, according to certain embodiments, or largely but not the whole specified according to other embodiments.

These and other modifications and variations may be practiced by those of ordinary skill in the art without departing from the spirit and scope, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the scope of that which is described in the claims. Therefore, the spirit and scope of the appended claims should not be limited to the exemplary description of the versions contained herein.

The following numbered clauses include embodiments that are contemplated and non-limiting:

Clause 1. A mold configured to form a polymeric article.

Clause 2. The mold of clause 1, any other suitable clause, or any suitable combination of clauses, the mold including a first mold portion.

Clause 3. The mold of clause 2, any other suitable clause, or any suitable combination of clauses, the first mold portion including a base surface and a sidewall surface extending in an axial direction away from the base surface, the base surface and the sidewall surface defining at least a portion of an interior space.

Clause 4. The mold of clause 3, any other suitable clause, or any suitable combination of clauses, the mold including a second mold portion configured to move relative to the first mold between an opened position, in which the second mold portion is spaced apart from the first mold portion and located outside of the interior space, and a closed position, in which at least a portion of the second mold portion extends into the interior space of the first mold portion to define a mold cavity between the first mold portion and the second mold portion.

Clause 5. The mold of clause 4, any other suitable clause, or any suitable combination of clauses, wherein the mold cavity is configured to receive a molten polymeric material to form the polymeric article between the first mold portion and the second mold portion.

Clause 6. The mold of clause 5, any other suitable clause, or any suitable combination of clauses, wherein the second mold portion includes an interior mold core configured to interface with the base surface of the first mold portion and an exterior mold core configured to interface with the sidewall surface of the first mold portion and formed to include a core interior configured to receive the interior mold core therein.

Clause 7. The mold of clause 6, any other suitable clause, or any suitable combination of clauses, wherein the exterior mold core is configured to move relative to the interior mold core when the second mold portion is in the closed position during a molding operation from a first mold position, in which a distal end of the interior mold core is spaced a first distance from a distal end of the exterior mold core, and a second mold position, in which the distal end of the exterior mold core is spaced a second distance, greater than the first distance, from the distal end of the interior mold core to enlarge the cavity between the first mold portion and the second mold portion and provide the polymeric article with a first projection extending inwardly toward a central axis of the polymeric article.

Clause 8. The mold of clause 7, any other suitable clause, or any suitable combination of clauses, wherein the exterior mold core includes an inner surface defining the core interior and an outer surface having a tapered surface arranged at an angle to the axial direction of the exterior mold core and a planar surface parallel to the axial direction of the exterior mold core.

Clause 9. The mold of clause 8, any other suitable clause, or any suitable combination of clauses, wherein the planar surface is located in the interior space in the first mold position and is located outside of the interior space in the second mold position.

Clause 10. The mold of clause 8, any other suitable clause, or any suitable combination of clauses, wherein the second mold portion further includes a seal ring configured to engage with the planar surface and with a top end of the first mold portion at an outer edge of an inlet into the interior space to provide a seal between the first mold portion and the second mold portion when the exterior mold core is in the first and second molding positions.

Clause 11. The mold of clause 7, any other suitable clause, or any suitable combination of clauses, wherein the exterior mold core includes a first movable core defining the core interior, and a second movable core defining a second core interior configured to receive the first movable core.

Clause 12. The mold of clause 11, any other suitable clause, or any suitable combination of clauses, wherein the second movable core is configured to translate relative to the first movable core, the interior core, and the first mold portion to widen a second portion of the cavity and provide a second projection in the polymeric article spaced apart from the first projection in the axial direction.

Clause 13. The mold of clause 12, any other suitable clause, or any suitable combination of clauses, wherein one of the first projection and the second projection is a stacking shoulder.

Clause 14. The mold of clause 7, any other suitable clause, or any suitable combination of clauses, wherein the cavity increases in width along an entirety of a height of the sidewall surface of the first mold portion as the exterior mold core moves from the first mold position to the second mold position.

Clause 15. A method of forming a polymeric article.

Clause 16. The method of clause 15, any other suitable clause, or any suitable combination of clauses, the method including establishing a mold cavity between a first mold portion and a second mold portion.

Clause 17. The method of clause 16, any other suitable clause, or any suitable combination of clauses, the method including injecting molten polymeric material into the mold cavity between the first mold portion and the second mold portion.

Clause 18. The method of clause 17, any other suitable clause, or any suitable combination of clauses, the method including foaming the polymeric material within the mold cavity.

Clause 19. The method of clause 18, any other suitable clause, or any suitable combination of clauses, the method including, moving a portion of the second mold portion relative to the first mold portion to enlarge the mold cavity in at least one selected region to cause the polymeric article to have a first density in the at least one selected region and a second density, greater than the first density, in a second region offset axially from the at least one selected region relative to a central axis of the polymeric article.

Clause 20. The method of clause 19, any other suitable clause, or any suitable combination of clauses, wherein during the step of foaming, the portion of the second mold portion translates relative to the first mold portion from a first mold position extending a first distance into the mold cavity to a second mold position extending a second distance less than the first distance into the mold cavity.

Clause 21. The method of clause 19, any other suitable clause, or any suitable combination of clauses, wherein the first mold portion and the second mold portion remain in contact with the polymeric material until the polymeric material is at least partially solidified.

Clause 22. The method of clause 21, any other suitable clause, or any suitable combination of clauses, wherein first mold portion forms a first high-density layer in the polymeric article, the second mold portion forms a second high-density layer in the polymeric article, and a low-density medial layer is formed between the first high-density layer and the second high-density layer as the polymeric material foams.

Clause 23. The method of clause 19, any other suitable clause, or any suitable combination of clauses, further comprising a step of inserting a label into the mold cavity prior to the polymeric material being injected into the mold cavity.

Clause 24. The method of clause 19, any other suitable clause, or any suitable combination of clauses, further comprising a step of cooling the polymeric material in the mold cavity by circulating a cooling fluid in one or both of the first mold portion and the second mold portion.

Clause 25. The method of clause 19, any other suitable clause, or any suitable combination of clauses, wherein the polymeric article has a first thickness in the at least one selected region and a second thickness less than the first thickness in the second region.

Clause 26. The method of clause 25, any other suitable clause, or any suitable combination of clauses, wherein the at least one selected region extends a first length along a height of the polymeric article and the second region extends a second length along the height of the polymeric article, the second length is greater than the first length.

Clause 27. A polymeric article.

Clause 28. The polymeric article of clause 27, any other suitable clause, or any suitable combination of clauses, wherein the polymeric article is cellular.

Clause 29. The polymeric article of clause 27, any other suitable clause, or any suitable combination of clauses, including a floor.

Clause 30. The polymeric article of clause 29, any other suitable clause, or any suitable combination of clauses, including a brim spaced apart from the floor in a vertical or axial direction.

Clause 31. The polymeric article of clause 30, any other suitable clause, or any suitable combination of clauses, including a sidewall extending between and interconnecting the floor and the brim.

Clause 32. The polymeric article of clause 31, any other suitable clause, or any suitable combination of clauses, wherein the sidewall includes an upper sidewall section.

Clause 33. The polymeric article of clause 32, any other suitable clause, or any suitable combination of clauses, wherein the sidewall includes a lower sidewall section.

Clause 34. The polymeric article of clause 33, any other suitable clause, or any suitable combination of clauses, wherein the sidewall includes and a medial sidewall section.

Clause 35. The polymeric article of clause 34, any other suitable clause, or any suitable combination of clauses, wherein the upper and lower sidewall sections each having a varying average density in at least a portion thereof, and the medial sidewall section having a substantially constant average density throughout an entirety of the medial sidewall section.

Clause 36. The polymeric article of clause 35, any other suitable clause, or any suitable combination of clauses, wherein the upper sidewall section and/or the medial sidewall section have a first thickness and the lower sidewall section has a second thickness greater than the first thickness.

Clause 37. The polymeric article of clause 36, any other suitable clause, or any suitable combination of clauses, wherein the sidewall has an outer surface extending along the upper sidewall section, the lower sidewall section, and the medial sidewall section and an inner surface extending along the upper sidewall section, the lower sidewall section, and the medial sidewall section, and wherein the outer surface has a constant increase in diameter along a height of the sidewall and the inner surface has a variable change in diameter along the height of the sidewall.

Clause 38. The polymeric article of clause 37, any other suitable clause, or any suitable combination of clauses, wherein the inner surface has a substantially constant diameter along a height of the lower sidewall section and a constant increase in diameter along a height of the medial sidewall section.

Clause 39. The polymeric article of clause 37, any other suitable clause, or any suitable combination of clauses, wherein the inner surface has a substantially constant diameter along a height of the lower sidewall section, a constant increase in diameter along a first portion of the medial sidewall section, and a second substantially constant diameter along a second portion of the medial sidewall section spaced apart from the substantially constant diameter along the height of the lower sidewall section.

Clause 40. The polymeric article of clause 37, any other suitable clause, or any suitable combination of clauses, wherein the inner surface does not decrease in diameter from the floor to the brim.

Clause 41. The polymeric article of clause 37, any other suitable clause, or any suitable combination of clauses, wherein the sidewall includes an inner layer having a first density, an outer layer having the first density, and a core layer between the inner layer and the outer layer having a second density less than the first density.

Clause 42. The polymeric article of clause 37, any other suitable clause, or any suitable combination of clauses, further comprising a film laminated on the outer surface.

Clause 43. The polymeric article of clause 42, any other suitable clause, or any suitable combination of clauses, wherein the film includes ink printed thereon.

Clause 44. The polymeric article of clause 37, any other suitable clause, or any suitable combination of clauses, wherein the brim has a curved upper surface and a distal end providing an outermost diameter of the polymeric article.

1. A mold configured to form a polymeric article, the mold comprising:
a first mold portion including a base surface and a sidewall surface extending in an axial direction away from the base surface, the base surface and the sidewall surface defining at least a portion of an interior space, and
a second mold portion configured to move relative to the first mold between an opened position, in which the second mold portion is spaced apart from the first mold portion and located outside of the interior space, and a closed position, in which at least a portion of the second mold portion extends into the interior space of the first mold portion to define a mold cavity between the first mold portion and the second mold portion, the mold cavity is configured to receive a molten polymeric material to form the polymeric article between the first mold portion and the second mold portion,
wherein the second mold portion includes an interior mold core configured to interface with the base surface of the first mold portion and an exterior mold core configured to interface with the sidewall surface of the first mold portion and formed to include a core interior configured to receive the interior mold core therein,
wherein the exterior mold core is configured to move relative to the interior mold core when the second mold portion is in the closed position during a molding operation from a first mold position, in which a distal end of the interior mold core is spaced a first distance from a distal end of the exterior mold core, and a second mold position, in which the distal end of the exterior mold core is spaced a second distance, greater than the first distance, from the distal end of the interior mold core to enlarge the cavity between the first mold portion and the second mold portion and provide the polymeric article with a first projection extending inwardly toward a central axis of the polymeric article.

2. The mold of claim 1, wherein the exterior mold core includes an inner surface defining the core interior and an outer surface having a tapered surface arranged at an angle to the axial direction of the exterior mold core and a planar surface parallel to the axial direction of the exterior mold core.

3. The mold of claim 2, wherein the planar surface is located in the interior space in the first mold position and is located outside of the interior space in the second mold position.

4. The mold of claim 2, wherein the second mold portion further includes a seal ring configured to engage with the planar surface and with a top end of the first mold portion at an outer edge of an inlet into the interior space to provide a seal between the first mold portion and the second mold portion.

5. The mold of claim 1, wherein the exterior mold core includes a first movable core defining the core interior, and a second movable core defining a second core interior configured to receive the first movable core.

6. The mold of claim 5, wherein the second movable core is configured to translate relative to the first movable core, the interior core, and the first mold portion to widen a second portion of the cavity and provide a second projection in the polymeric article spaced apart from the first projection in the axial direction.

7. The mold of claim 6, wherein one of the first projection and the second projection is a stacking shoulder.

8. The mold of claim 1, wherein the cavity increases in width along an entirety of a height of the sidewall surface of the first mold portion as the exterior mold core moves from the first mold position to the second mold position.

9. A method of forming a polymeric article, the method comprising steps of:
establishing a mold cavity between a first mold portion and a second mold portion,
injecting molten polymeric material into the mold cavity between the first mold portion and the second mold portion,
foaming the polymeric material within the mold cavity, and
as the polymeric material foams, moving a portion of the second mold portion relative to the first mold portion to enlarge the mold cavity in at least one selected region to cause the polymeric article to have a first density in the at least one selected region and a second density, greater than the first density, in a second region offset axially from the at least one selected region relative to a central axis of the polymeric article.

10. The method of claim 9, wherein during the step of foaming, the portion of the second mold portion translates relative to the first mold portion from a first mold position extending a first distance into the mold cavity to a second mold position extending a second distance less than the first distance into the mold cavity.

11. The method of claim 9, wherein the first mold portion and the second mold portion remain in contact with the polymeric material until the polymeric material is at least partially solidified.

12. The method of claim 11, wherein first mold portion forms a first high-density layer in the polymeric article, the second mold portion forms a second high-density layer in the polymeric article, and a low-density medial layer is formed between the first high-density layer and the second high-density layer as the polymeric material foams.

13. The method of claim 9, further comprising a step of inserting a label into the mold cavity prior to the polymeric material being injected into the mold cavity.

14. The method of claim 9, further comprising a step of cooling the polymeric material in the mold cavity by circulating a cooling fluid in one or both of the first mold portion and the second mold portion.

15. The method of claim 9, wherein the polymeric article has a first thickness in the at least one selected region and a second thickness less than the first thickness in the second region.

16. The method of claim 15, wherein the at least one selected region extends a first length along a height of the polymeric article and the second region extends a second length along the height of the polymeric article, the second length is greater than the first length.

17. A cellular, polymeric article comprising:
a floor,
a brim spaced apart from the floor in an axial direction along a central axis of the polymeric article, and
a sidewall extending between and interconnecting the floor and the brim,
wherein the sidewall includes an upper sidewall section, a lower sidewall section, and a medial sidewall section between the upper sidewall section and the lower sidewall section, the upper and lower sidewall sections each having a varying average density in at least a portion thereof, and the medial sidewall section having a substantially constant average density throughout an entirety of the medial sidewall section.

18. The polymeric article of claim 17, wherein upper sidewall section and the medial sidewall section have a first thickness and the lower sidewall section has a second thickness greater than the first thickness.

19. The polymeric article of claim 17, wherein the sidewall has an outer surface extending along the upper sidewall section, the lower sidewall section, and the medial sidewall section and an inner surface extending along the upper sidewall section, the lower sidewall section, and the medial sidewall section, and wherein the outer surface has a constant increase in diameter along a height of the sidewall and the inner surface has a variable change in diameter along the height of the sidewall.

20. The polymeric article of claim 19, wherein the inner surface has a substantially constant diameter along a height of the lower sidewall section and a constant increase in diameter along a height of the medial sidewall section.
